(19) United States
(12) Patent Application Publication
(10) Pub. No.: US 2010/0267888 A1
(43) Pub. Date: Oct. 21, 2010

(54) POLYVINYL ALCOHOL FIBER-CONTAINING POLYOLEFIN RESIN COMPOSITION AND MOLDED ARTICLE THEREOF

(75) Inventors: Takashi Katayama, Okayama (JP); Ushio Suzuki, Osaka (JP); Katsuhisa Kitano, Rabigh (SA)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignees: KURARAY CO., LTD., Kurashiki-shi, Okayama (JP); SUMITOMO CHEMICAL COMPANY, LIMITED, Chuo-ku, Tokyo (JP)

(21) Appl. No.: 12/744,506

(22) PCT Filed: Dec. 5, 2008
(86) PCT No.: PCT/JP2008/072168

§ 371 Date: May 25, 2010

(30) Foreign Application Priority Data
Dec. 5, 2007 (JP) 2007-314420

(51) Int. Cl. C08L 29/04

(52) U.S. Cl. 524/503

(57) ABSTRACT

A polyvinyl alcohol fiber-containing polyolefin resin composition, comprising: 1 to 70% by weight of polyvinyl alcohol fibers (A) containing 100 parts by weight of polyvinyl alcohol filaments (A-I) and 0.1 to 10 parts by weight of a sizing agent (A-II); and 30 to 99% by weight of a polyolefin resin composition (I), wherein the polyolefin resin composition (I) contains 0.5 to 40% by weight of a modified polyolefin resin (B) produced by modifying a polyolefin resin with an unsaturated carboxylic acid and/or an unsaturated carboxylic acid derivative and 60 to 99.5% by weight of a polyolefin resin (C) with respect to the total weight of the polyolefin resin composition (I).

### TECHNICAL FIELD

The present invention relates to a polyvinyl alcohol fiber-containing polyolefin resin composition and molded articles thereof.

### BACKGROUND ART

It has been conventionally known that fillers or fibers are incorporated in a polyolefin resin as means to improve mechanical strength such as rigidity and impact strength thereof.

Lightweight filler-containing resin products have been strongly desired in accordance with recent increase in the demand for ecological compatibility. As a specific example, it is contemplated to incorporate organic fibers to improve mechanical strength such as rigidity and impact strength of the polyolefin resin.

Japanese Patent Laid-Open Publication No. S48-42035 describes injection molded articles obtained by dry blending a polypropylene resin and a vinylon fibers sized with an ethylene-vinyl acetate copolymer resin.

A sheet in which a polypropylene resin, a polyethylene resin, wood powders and vinylon fibers bundled up with a sizing agent are composed is described in Japanese Patent Laid-Open Publication No. H11-279416.

A polypropylene resin reinforced with polyvinyl alcohol fibers which are not subjected to surface treatment is described in Chapter 10 of “Seihin sekkei no tameno sen'i juten polymer kei composite” (“Fiber filled polymer composite for product designing” (written by Zen'ichiro Maekawa et al., IPC company (published in 2004)).

Patent Document 1: Japanese Patent Laid-Open Publication No. S48-42035

Patent Document 2: Japanese Patent Laid-Open Publication No. H11-279416

Non-Patent Document 1: “Seihin sekkei no tameno sen'i juten polymer kei composite” (“Fiber filled polymer composite for product designs”)

### DISCLOSURE OF THE INVENTION

### Problems to be Solved by the Invention

Under the circumstances, an object of the present invention is to provide a polyvinyl alcohol fiber-containing polyolefin resin composition having improved tensile strength and flexural strength.

### Means for Solving the Problem

The present inventors have conducted extensive studies in consideration of such a situation and consequently have found that the problems mentioned above could be solved by the present invention and thus completed the present invention.

The present invention relates to a polyvinyl alcohol fiber-containing polyolefin resin composition, comprising: 1 to 70% by weight of polyvinyl alcohol fibers (A) containing 100 parts by weight of polyvinyl alcohol filaments (A-I) and 0.1 to 10 parts by weight of a sizing agent (A-II); and 30 to 99% by weight of a polyolefin resin composition (I), wherein the polyolefin resin composition (I) contains 0.5 to 40% by weight of a modified polyolefin resin (B) produced by modifying a polyolefin resin with an unsaturated carboxylic acid and/or an unsaturated carboxylic acid derivative and 60 to 99.5% by weight of a polyolefin resin (C) with respect to the total weight of the polyolefin resin composition (I).

### EFFECT OF THE INVENTION

According to the present invention, a polyvinyl alcohol fiber-containing polyolefin resin composition and molded articles thereof having improved tensile strength and flexural strength can be obtained.

### BEST MODES FOR CARRYING OUT THE INVENTION

The polyvinyl alcohol fiber-containing polyolefin resin composition of the present invention comprises polyvinyl alcohol fibers (A) containing polyvinyl alcohol filaments (A-I) and a sizing agent (A-II) and a polyolefin resin composition (I). Here, the polyolefin resin composition (I) contains a modified polyolefin resin (B) produced by modifying a polyolefin resin with an unsaturated carboxylic acid and/or an unsaturated carboxylic acid derivative and a polyolefin resin (C). Hereinbelow, the respective components are described in detail.

The polyvinyl alcohol fibers (A) are polyvinyl alcohol filaments (A-I) applied with a sizing agent (A-II).

The method of applying the polyvinyl alcohol filaments (A-I) with a sizing agent is not limited in particular, but examples thereof include a method comprising immersing filaments in a tank in which a sizing agent is placed, being nipped and then drying in an hot-air oven, or with a hot roller or a hot plate.

The production process of the polyvinyl alcohol filaments (A-I) is not limited in particular, but it is preferable to produce fibers by a wet spinning method or a dry spinning method. Here, the wet spinning method is a method comprising discharging a spinning solution prepared by dissolving a polyvinyl alcohol polymer in water or an organic solvent directly from a spinneret to a solidification bath which contains water or an organic solvent having a capability of solidifying the polyvinyl alcohol polymer. On the other hand, the dry spinning method is a method comprising discharging a spinning solution into the air or an inert gas from a spinneret once and then introducing it into a solidification bath. The constitution of a polyvinyl alcohol polymer used for the present invention is not limited in particular, but it has preferably an average polymerization degree of not less than 1000, and further preferably not less than 1200, and preferably not more than 5000, and particularly preferably not more than 4000, from the viewpoint of mechanical characteristics, heat resistance and so on. It is also preferable that the saponification degree is not less than 99 mol %, more preferably not less than 99.8 mol % for the similar reasons. The polyvinyl alcohol polymer which constitutes the fibers may be modified or copolymerized with other components. Here, the average polymerization degree and saponification degree of the polyvinyl alcohol polymer are measured in accordance with JIS K6726.

Example of the sizing agent (A-II) include polyolefin resin, polyurethane resin, polyester resin, acrylic resin, epoxy resin, starch, vegetable oil, modified polyolefin.

Above all, polyolefin resin, polyurethane resin, epoxy resin, modified polyolefin resin are preferable, and polyolefin resin and modified polyolefin resin are more preferable, and polypropylene resin and modified polypropylene resin are still more preferable. Examples of the modified polyolefin include acid modified polyolefin. These resins may be used alone or two or more of them may be used in combination.

The application amount of the sizing agent (A-II) with respect to the polyvinyl alcohol filaments (A-I) is 0.1 to 10 parts by weight of the sizing agent (A-II) with respect to 100 parts by weight of the polyvinyl alcohol filaments (A-I). The application amount is preferably 0.1 to 7 parts by weight, and more preferably 0.2 to 5 parts by weight.

When the application amount of the sizing agent (A-II) is less than 0.1 parts by weight, sufficient sizing effect cannot be obtained and the polyvinyl alcohol fibers may entangle and/or turn up in the production of a resin composition in the form of a pellet by a pultrusion process as described later, which makes the production difficult. In addition, it is presumed that the effect comes from the functional groups of the sizing agent, which enhance the binding force at the interface between the polyvinyl alcohol filaments (A-I) and the polyolefin resin composition (I), and with a application amount of less than 0.1 parts by weight, sufficient strength or physical properties cannot be obtained when a polyvinyl alcohol fiber-containing polyolefin resin composition is molded.

When the application amount of the sizing agent (A-II) is more than 10 parts by weight, sufficient strength or physical properties cannot be obtained, which may be because the sizing agent (A-II) works as an alien substance at the interface between the polyvinyl alcohol filaments (A-I) and the polyolefin resin composition (I).

A surface treating agent may be incorporated in the sizing agent (A-II) to improve the wettability or adhesiveness between the polyvinyl alcohol filaments (A-I) and the polyolefin resin composition (I).

Examples of the surface treating agent include silane coupling agents, titanate coupling agents, aluminum coupling agents, chromium coupling agents, zirconium coupling agents, borane coupling agents, and preferred are silane coupling agents or titanate coupling agents, and more preferably silane coupling agents.

Examples of the above-mentioned silane coupling agents include triethoxysilane, vinyltris(β-methoxyethoxy)silane, γ-methacryloxypropyl trimethoxysilane, γ-glycidoxypropyltrimethoxysilane, β-(3,4-epoxycyclohexyl)ethyl trimethoxysilane, N-β-(aminoethyl)-γ-aminopropyltrimethoxysilane, N-β-(aminoethyl)-γ-aminopropylmethyldimethoxysilane, γ-aminopropyltriethoxysilane, N-phenyl-γ-aminopropyltrimethoxysilane, γ-mercaptopropyltrimethoxysilane, γ-chloropropyltrimethoxysilane, and preferred are aminosilanes such as γ-aminopropyltriethoxysilane and N-β-(aminoethyl)-γ-aminopropyltrimethoxysilane.

In addition to or in place of the surface treating agents, lubricants such as paraffin wax may be incorporated in the sizing agent (A-II).

The polyolefin resin composition (I) contains a modified polyolefin resin (B) produced by modifying the polyolefin resin with an unsaturated carboxylic acid and/or an unsaturated carboxylic acid derivative, and a polyolefin resin (C) as mentioned above.

The polyolefin resin serving as a raw material of modified polyolefin resin (B) is a resin consisting of a homopolymer of one kind of olefin or a copolymer of two or more kinds of olefins. The modified polyolefin resin (B), in other words, is a resin generated by reacting a homopolymer of one kind of olefin or a copolymer of two or more kinds of olefins with an unsaturated carboxylic acid and/or an unsaturated carboxylic acid derivative, and is a resin having a partial structure derived from the unsaturated carboxylic acid or unsaturated carboxylic acid derivative in the molecule.

Example of the modified polyolefin resin (B) include the following modified polyolefin resins (B-a) to (B-C). As the modified polyolefin resin (B), these modified polyolefin resins may be used alone or two or more of them may be used in combination.

(B-a) Modified polyolefin resin obtained by graft polymerization of an unsaturated carboxylic acid and/or an unsaturated carboxylic acid derivative onto an olefin homopolymer;

(B-b) Modified polyolefin resin obtained by graft polymerization of an unsaturated carboxylic acid and/or an unsaturated carboxylic acid derivative onto a copolymer obtained by copolymerizing two or more kinds of olefins; and

(B-c) Modified polyolefin resin obtained by graft polymerization of an unsaturated carboxylic acid and/or an unsaturated carboxylic acid derivative onto a block copolymer obtained by homopolymerizing an olefin and then copolymerizing two or more kinds of olefins therewith.

The modified polyolefin resin (B) can be produced by a solution method, bulk method, melt kneading method and so on. Two or more of these methods may be used in combination.

Specific examples of the solution method, bulk method, melt kneading method and so on include methods described in, for example, “Jitsuyo polymer alloy sekkei” (“Practical polymer alloy designing”) (written by Fumio Ide, Kogyo Chosakai Publishing, Inc. (published in 1996)), Prog. Polym. Sci., 24, 81-142 (1999), Japanese Patent Laid-Open Publication No. 2002-308947, Japanese Patent Laid-Open Publication No. 2004-292581, Japanese Patent Laid-Open Publication No. 2004-217753 and Japanese Patent Laid-Open Publication No. 2004-217754.

For modified polyolefin resin (B), commercially available modified polyolefin resins may be used, and examples thereof include Modiper (product name; produced by NOF Corporation.), Blemmer CP (product name; produced by NOF Corporation.), Bondfast (product name; produced by Sumitomo Chemical Co., Ltd.), Bondine (product name; produced by Sumitomo Chemical Co., Ltd.), Rexpearl (product name; produced by Japan Polyethylene Co., Ltd.), Admer (product name; produced by Mitsui Chemicals, Inc.), Modic AP (product name; produced by Mitsubishi Chemical Corp.), Polybond (product name; produced by Crompton Co., Ltd.), Umex (product name; produced by Sanyo Chemical Industries, Ltd.).

Examples of the unsaturated carboxylic acid used for the production of the modified polyolefin resin (B) include maleic acid, fumaric acid, itaconic acid, acrylic acid, methacrylic acid.

The unsaturated carboxylic acid derivatives include acid anhydrides, ester compounds, amides compounds, imide compounds, metal salts of unsaturated carboxylic acids, and specific examples thereof include maleic anhydride, itaconic anhydride, methyl acrylate, ethyl acrylate, butyl acrylate, glycidyl acrylate, methyl methacrylate, ethyl methacrylate, butyl methacrylate, glycidyl methacrylate, 2-hydroxyethyl methacrylate, monoethyl maleate, diethyl maleate, monomethyl fumarate, dimethyl fumarate, acrylamide, methacrylamide, maleic monoamide, maleic diamide, fumaric monoamide, maleimide, N-butyl maleimide, and sodium methacrylate.

Those which generate an unsaturated carboxylic acid by dehydrating at a step of grafting onto a polyolefin like citric acid and malic acid may be also used.

Preferable unsaturated carboxylic acid derivatives are glycidyl ester of acrylic acid and methacrylic acid, maleic anhydride, 2-hydroxyethyl methacrylate.

Preferable modified polyolefin resin (B) is the following (B-d).

(B-d) Modified polyolefin resin obtained by graft polymerization of maleic anhydride or glycidyl methacrylate ester or 2-hydroxyethyl methacrylate onto a polyolefin resin containing units derived from olefins of ethylene and/or propylene as main constitutional units.

The content of the constitutional unit derived from an unsaturated carboxylic acid and/or an unsaturated carboxylic acid derivative contained in the modified polyolefin resin (B) is preferably 0.1 to 10% by weight, more preferably 0.1 to 5% by weight, still more preferably 0.2 to 2% by weight, and particularly preferably 0.4 to 1% by weight from the viewpoint of mechanical strength such as impact strength, fatigue characteristics, and rigidity. The content of the constitutional unit derived from an unsaturated carboxylic acid and/or an unsaturated carboxylic acid derivative is the value determined by quantification of absorption attributable to the unsaturated carboxylic acid and/or the unsaturated carboxylic acid derivative by an infrared absorption spectrum or an NMR spectrum.

The polyolefin resin (C) which the polyolefin resin composition (I) contains is a resin consisting of a homopolymer of one kind of olefin or a copolymer of two or more kinds of olefins, and the resins modified with an unsaturated carboxylic acid and an unsaturated carboxylic acid derivative do not fall under this.

Specifically, polypropylene resin and polyethylene resin may be included. Polypropylene resin is preferable as a polyolefin resin. These polyolefin resins may be used alone or two or more of them may be used in combination.

Examples of the polypropylene resin include propylene homopolymers, propylene-ethylene random copolymers, propylene-α-olefin random copolymers, propylene-ethylene-α-olefin random copolymers, propylene block copolymers obtained by copolymerizing ethylene and propylene after polymerizing propylene alone. Polypropylene resin preferred from the viewpoint of heat resistance is propylene homopolymer and propylene block copolymers obtained by copolymerizing ethylene and propylene after polymerizing propylene alone.

Here, the ethylene content contained in the propylene-ethylene random copolymer (assuming the total content of propylene and ethylene as 100 mol %), the α-olefin content contained in the propylene-α-olefin random copolymer (assuming the total content of propylene and the α-olefin as 100 mol %) and the total content of ethylene and α-olefin contained in the propylene-ethylene-α-olefin random copolymer (assuming the total content of propylene, ethylene and the α-olefin as 100 mol %) are respectively less than 50 mol %. The above-mentioned ethylene content, α-olefin content and ethylene and α-olefin content of in total are measured by IR method or NMR method described in “Shinban koubunshi-bunseki handbook” (“New edition of Polymer Analysis Handbook”) (edited by Chemical Society of Japan, Polymer Analysis Study Round-table Conference, Kinokuniya (1995)).

Examples of the polyethylene resin include ethylene homopolymers, ethylene-propylene random copolymers and ethylene-α-olefin random copolymers.

Here, the propylene content contained in the ethylene-propylene random copolymer (assuming the total content of ethylene and propylene as 100 mol %), the α-olefin content contained in the ethylene-α-olefin random copolymer (assuming the total content of ethylene and the α-olefin as 100 mol %) and the total content of propylene and α-olefin contained in the ethylene-propylene-α-olefin random copolymer (assuming the total content of ethylene, propylene and the α-olefin as 100 mol %) are respectively less than 50 mol %.

Examples of the α-olefin include 1-butene, 2-methyl-1-propene, 2-methyl-1-butene, 3-methyl-1-butene, 1-hexene, 2-ethyl-1-butene, 2,3-dimethyl-1-butene, 2-methyl-1-pentene, 3-methyl-1-pentene, 4-methyl-1-pentene, 3,3-dimethyl-1-butene, 1-heptene, methyl-1-hexene, dimethyl-1-pentene, ethyl-1-pentene, trimethyl-1-butene, methylethyl-1-butene, 1-octene, methyl-1-pentene, ethyl-1-hexene, dimethyl-1-hexene, propyl-1-heptene, methylethyl-1-heptene, trimethyl-1-pentene, propyl-1-pentene, diethyl-1-butene, 1-nonene, 1-decene, 1-undecene and 1-dodecen. Preferred are α-olefins having 4 to 8 carbon atoms (for example, 1-butene, 1-pentene, 1-hexene and 1-octene).

The polyolefin resin (C) can be produced by a solution polymerization method, a slurry polymerization method, a bulk polymerization method, a vapor phase polymerization method and so on. These polymerization methods may be used alone or two or more of them may be used in combination.

More specific examples of the production process of the polyolefin resin (C) include the polymerization method described in “Shin polymer seizou process” (“New Polymer Production Process” (edited by Koji Saeki, Kogyo Chosakai Publishing, Inc. (published in 1994)), Japanese Patent Laid-Open Publication No. H04-323207, Japanese Patent Laid-Open Publication No. S61-287917.

Multisite catalysts and single site catalysts may be included as a catalyst used for the production of the polyolefin resin (C). Preferable multisite catalysts include catalysts obtained with a solid catalyst component containing a titanium atom, a magnesium atom and a halogen atom, and preferable single site catalysts include a metallocene catalyst.

The preferable catalyst which can be used for the production of a polypropylene resin as the polyolefin resin (C) includes a catalyst obtained by using a solid catalyst component which contains a titanium atom, a magnesium atom and a halogen atom mentioned above.

The melt flow rate (MFR) of the polyolefin resin (C) is preferably 1 to 500 g/10 min, more preferably 10 to 400 g/10 min, further preferably 20 to 300 g/10 min, still more preferably 50 to 200 g/10 min from a viewpoint of preventing deterioration in the dispersibility of the polyvinyl alcohol fibers (A) in the molded articles, deterioration in the appearance and the impact strength of the molded articles. Here, MFR is the value measured at 230° C., 21.2N load according to A.S.T.M.D1238.

When the polyolefin resin (C) used in the present invention is a propylene homopolymer, the isotactic pentad fraction thereof is preferably 0.95 to 1.0, more preferably 0.96 to 1.0, and still more preferably 0.97 to 1.0. The isotactic pentad fraction is measured by the method disclosed by A. Zambelli et al. in Macromolecules, vol. 6, p. 925 (1973); namely, it represents a fraction of propylene monomer units present at the center of an isotactic chain in the form of a pentad unit in the propylene molecular chain, i.e., a fraction of propylene monomer units at the center of a chain in which five propylene monomer units are successively meso-bonded in the propylene molecular chain, as measured using ¹³C-NMR. NMR absorption peaks are assigned according to the disclosure of Macromolecules, vol. 8, p. 687 (1975).

When the polyolefin resin (C) used in the present invention is a propylene block copolymer obtained by copolymerizing ethylene and propylene after polymerizing propylene alone, the isotactic pentad fraction thereof is preferably 0.95 to 1.0, more preferably 0.96 to 1.0, and still more preferably 0.97 to 1.0.

The content of the modified polyolefin resin (B) and the content of polyolefin resin (C) with respect to the total amount of the polyolefin resin composition (I) are respectively 0.5 to 40% by weight and 60 to 99.5% by weight.

The content of the polyolefin resin (B) and the content of polyolefin resin (C) with respect to the total amount of the polyolefin resin composition (I) are preferably 0.5 to 30% by weight and 70 to 99.5% by weight, respectively, more preferably 0.5 to 20% by weight and 80 to 99.5% by weight and still more preferably 0.5 to 10% by weight and 90 to 99.5% by weight from the viewpoint of the mechanical strength such as the rigidity and impact strength of the polyvinyl alcohol fiber-containing polyolefin resin composition and the molded articles thereof and from the viewpoint of production stability of the polyvinyl alcohol fiber-containing polyolefin resin composition.

In addition, the content of the polyvinyl alcohol fibers (A) and the content of the polyolefin resin composition (I) in the polyvinyl alcohol fiber-containing polyolefin resin composition are 1 to 70% by weight and 30 to 99% by weight respectively.

The content of the polyvinyl alcohol fibers (A) and the content of the polyolefin resin composition (I) in the polyvinyl alcohol fiber-containing polyolefin resin composition are preferably 5 to 65% by weight and 35 to 95% by weight, respectively, more preferably 10 to 60% by weight and 40 to 90% by weight and still more preferably 20 to 50% by weight and 50 to 80% by weight from the viewpoint of the mechanical strength such as the rigidity and impact strength of the polyvinyl alcohol fiber-containing polyolefin resin composition and the molded articles thereof and from the viewpoint of production stability of the polyvinyl alcohol fiber-containing polyolefin resin composition.

Examples of the production process of the polyolefin resin composition (I) include a method of mixing the total amounts of the polyolefin resin (C) and the modified polyolefin resin (B) to form a mixture and melt kneading the mixture.

The weight average fiber length of polyvinyl alcohol fiber (A) used in a polyvinyl alcohol fiber-containing polyolefin resin composition of the present invention is preferably 2 to 50 mm, preferably 3 to 20 mm, and particularly preferably 5 to 15 mm from the viewpoint of improving the mechanical strength such as the rigidity and impact strength thereof and facilitating the production and molding of the resin composition.

Here, the above-mentioned weight average fiber length of the polyvinyl alcohol fibers (A) is a length in the polyvinyl alcohol fiber-containing polyolefin resin composition of the present invention. The weight average fiber length of the polyvinyl alcohol fibers (A) is a value obtained by separating the polyvinyl alcohol fibers (A) from the polyvinyl alcohol fiber-containing polyolefin resin composition by well-known technology such as solvent extraction and then measuring the separated polyvinyl alcohol fibers (A) by the method described in Japanese Patent Laid-Open Publication No. 2002-5924 (the incineration step is excluded).

The polyolefin resin composition (I) may optionally contain one or more than one elastomer. Examples of elastomers include polyester-based elastomers, polyurethane-based elastomers, PVC-based elastomers, and mixtures thereof.

Furthermore, the polyvinyl alcohol fiber-containing polyolefin resin composition of the present invention may optionally contain known materials added to general polyolefin resins; for example, stabilizers, such as antioxidants, heat stabilizers, neutralizers, and UV absorbents; antifoaming agents, flame retardants, flame retardant aids, dispersants, antistatic agents, lubricants, and anti-blocking agents, such as silica; coloring agents, such as dyes and pigments; plasticizers; nucleating agents; and crystallization accelerators.

The polyvinyl alcohol fiber-containing polyolefin resin composition of the present invention may further contain inorganic compounds in a plate or powder form, such as glass flakes, mica, glass powders, glass beads, talc, clay, alumina, carbon black, and wollastonite; and whiskers.

Examples of the production process of the polyvinyl alcohol fiber-containing polyolefin resin composition of the present invention include the following processes (1) to (3).

(1) A process comprising mixing all of the components to form a mixture and then melt kneading the mixture;
(2) A process comprising combining any of the components and mixing them individually to form a mixture and then melt kneading the mixture; and
(3) A pultrusion process or an electric wire covering method

Examples of the method for obtaining a mixture in the above-mentioned processes (1) and (2) include methods of mixing with a Henschel mixer, a ribbon blender, a blender, etc.

Examples of the method for performing melt kneading include methods for melt kneading with a Bambury mixer, a Labo Plastomill, a Brabender Plastograph, single screw or twin screw extruders.

As the production process of the polyvinyl alcohol fiber-containing polyolefin resin composition of the present invention, preferred is the pultrusion process or the electric wire covering method, more preferably the pultrusion process, from the viewpoint of easiness in producing the composition and mechanical strength such as rigidity and impact strength of the composition and the molded articles thereof. The pultrusion process is a method basically comprising impregnating fiber bunch with a resin while pulling a consecutive fiber bunch, and examples thereof include the following processes (3-1) to (3-3).

(3-1) A process comprising passing a fiber bunch through an impregnation tank in which an emulsion, a suspension or a solution which consists of a resin and a solvent is placed, impregnating the fiber bunch with the emulsion, suspension or solution; and then removing the solvent;
(3-2) A process comprising spraying a resin powder on a fiber bunch or passing a fiber bunch through a tank filled with a resin powder to allow the resin powder to adhere onto the fibers and then melting the resin powder to impregnate the fiber bunch with the resin; and
(3-3) A process comprising passing a fiber bunch through a crosshead while supplying a molten resin to the crosshead from an extruder or the like to impregnate the fiber bunch with the resin.

Preferred is a pultrusion process using the crosshead of the above (3-3), and more preferred is a pultrusion process using a crosshead described in Japanese Patent Laid-Open Publication No. H03-272830.

In the pultrusion process mentioned above, the resin impregnation operation may be performed at one step or divided to two steps. In addition, pellets produced by the pultrusion process and pellets produced by melt kneading method may be blended.

The length of the polyvinyl alcohol fiber-containing polyolefin resin composition having a pellet-like external shape and produced by the pultrusion process is preferably 2 to 50 mm from the viewpoint of obtaining molded articles having a high strength without deteriorating the ejection moldability when the polyvinyl alcohol fiber-containing polyolefin resin composition of the present invention is applied to injection molding. More preferable length is 3 to 20 mm, and particularly preferable length is 5 to 15 mm. When the length of the polyvinyl alcohol fiber-containing polyolefin resin composition having a pellet-like shape and produced by the pultrusion process is less than 2 mm, the improvement effect in rigidity, heat resistance and impact strength may be low. In the meantime, when the length is more than 50 mm, molding may be difficult.

The length of the polyvinyl alcohol fiber-containing polyolefin resin composition having a pellet-like shape and produced by the pultrusion process and the weight average fiber length of the polyvinyl alcohol fibers (A) contained therein are equal. The feature that the length of the polyvinyl alcohol fiber-containing polyolefin resin composition having a pellet-like shape and produced by the pultrusion process and the weight average fiber length of the polyvinyl alcohol fibers (A) contained therein are equal means that the weight average fiber length of the polyvinyl alcohol fibers (A), which is a value obtained by separating the polyvinyl alcohol fibers (A) from the polyvinyl alcohol fiber-containing polyolefin resin composition having a pellet-like shape and produced by the pultrusion process by well-known technology such as solvent extraction and then measuring the separated polyvinyl alcohol fibers (A) by the method described in Japanese Patent Laid-Open Publication No. 2002-5924 (the incineration step is excluded), is 90 to 110% of the length of the polyvinyl alcohol fiber-containing polyolefin resin composition having a pellet-like shape and produced by the pultrusion process.

Since the length of the polyvinyl alcohol fibers (A) is equal to the length of the polyvinyl alcohol fiber-containing polyolefin resin composition having a pellet-like shape and produced by the pultrusion process, the length of the polyvinyl alcohol fibers (A) in the polyvinyl alcohol fiber-containing polyolefin resin composition having a pellet-like shape is preferably 2 to 50 mm, more preferably 3 to 20 mm, and still more preferably 5 to 15 mm.

In addition, the polyvinyl alcohol fibers (A) are usually oriented in parallel to each other in the polyvinyl alcohol fiber-containing polyolefin resin composition having a pellet-like shape and produced by the pultrusion process.

The molded articles of the present invention are molded articles obtained from the polyvinyl alcohol fiber-containing polyolefin resin composition of the present invention. Injection molding method, injection compression method and extrusion method may be included as the molding method.

The molded articles of the present invention are preferably molded articles obtained from a polyvinyl alcohol fiber-containing polyolefin resin composition of the present invention and the weight average fiber length of polyvinyl alcohol fibers (A) contained in the above-mentioned molded articles is preferably not less than 1 mm. The weight average fiber length of polyvinyl alcohol fibers (A) contained in the above-mentioned molded articles is preferably 1 to 10 mm from the viewpoint of mechanical strength and durability of the molded articles.

Applications of molded articles of the present invention include automobile plastics parts including exterior parts for which mechanical strength, durability and good appearance are needed and interior parts for which heat resisting rigidity are required and parts in the engine.

Examples of the exterior parts include fenders, overfenders, grill guards, cowl louvers, hubcaps, side protectors, side moldings, side lower skirts, front grills, side steps, roof rails, rear spoilers, bumpers, and examples of the interior parts include lower instrument panels and trims, and examples of the parts in the engine including bumper beams, cooling fans, fan shrouds, lamp housings, car heater cases, fuse boxes an air cleaner cases.

Applications of molded articles of the present invention also include parts such as parts of various electric appliances, parts of various machines and parts of structures, and examples of the parts of various electric appliances include machine housings of electric tools, cameras, video cameras, microwave ovens, electric rice-cookers, pots, vacuum cleaners, personal computers, copiers, printers, FDD and CRT, and examples of the part of various machines include pump casings, and examples of the parts of the structures include tanks, pipes and frame works for buildings.

### EXAMPLES

Hereinbelow, the present invention is described by way of Examples and Comparative Examples but the present invention is not limited to these Examples.

The production process of the samples for evaluation used in Examples and Comparative Example is shown below.

### (1) Production Process of Polyvinyl Alcohol Fibers (A)

Polyvinyl alcohol filaments (A-I) are immersed in a tank in which the sizing agent is placed and dried at two steps of 120° C. and 160° C. in an air-heating furnace after nipping to obtain polyvinyl alcohol fibers (A) applied with the sizing agent. The adhesion rate of the sizing agent was determined from the change in the weight before and after the treatment.

### (2) Production Process of Fiber Reinforced Pellets

According to a method described in Japanese Patent Laid-Open Publication No. H03-121146, fiber reinforced pellets were produced having compositions shown in Table 1. The impregnation temperature was 200° C. and the taking up rate was 13 in/min.

### (3) Production Process of Samples for Evaluation

The samples for evaluation were produced using the following molding machine produced by Japan Steel Works under the following conditions by injection molding the fiber reinforced pellets obtained by the above (1).

### [Molding Machine]

Molding machine: Molding machine J150E produced by Japan Steel Works
Clamping force: 150 t
Screw: A deep-channel screw
Screw diameter: 46 mm

### Screw L/D: 20.3

### [Molding Conditions]

Cylinder temperature: 200° C.
Die temperature: 50° C.
Back pressure: 0 MPa

The evaluation methods in Examples and Comparative Examples are shown below.

### (1) Tensile Strength (Unit: MPa)

According to A.S.T.M D638, the measurement was performed under the following conditions.
Measurement temperature: 23° C.
Sample thickness: 3.2 mm
Taking up rate: 10 mm/min

### (2) Flexural Modulus (Unit: MPa)

Measured under the following conditions according to A.S.T.M D790:
Measurement temperature: 23° C.
Sample thickness: 3.2 mm

### Span: 50 mm

Taking up rate: 2 mm/min

### (3) Flexural Strength (Unit: MPa)

Measured under the following conditions according to A.S.T.M D790:
Measurement temperature: 23° C.
Sample thickness: 3.2 mm

### Span: 50 mm

Taking up rate: 2 mm/min
(4) IZOD Impact Strength (Unit: kJ/m²)
Measured under the following conditions according to A.S.T.M D 256.
Measurement temperature: 23° C.
Sample thickness: 3.2 mm [with a V notch]

### (5) Specific Gravity (Unit: −)

Measured under the following conditions according to A.S.T.M D792.

### (6) Weight Average Fiber Length (Unit: mm)

The resin was removed from the solvent by the Soxhlet extraction method (solvent: xylene), fibers were collected, and the weight average fiber length was measured by the method described in Japanese Patent Laid-Open Publication No. 2002-5924.

### Example 1

Fiber reinforced pellets having a fiber content of 26% by weight and a pellet length of 9 mm were produced according to the method described in Japanese Patent Laid-Open Publication No. H03-121146 with the composition described in Table 1. The length of the polyvinyl alcohol fiber of the obtained fiber reinforced pellets is 9 mm.

For the component (A), a component (A-1) obtained by applying 100 parts by weight of polyvinyl alcohol fiber produced by Kuraray Co., Ltd., vinylon (registered trademark) 5501-2 (fiber diameter, 14 μm; A-I) with 5 parts by weight of carboxylic acid modified polypropylene emulsion (Toho Kagaku, HYTEC P-6000, A-II) was used.

The modified polyolefin resin (B-1) used was a maleic anhydride modified polypropylene resin (MFR=60 g/10 min; amount of grafted maleic anhydride=0.6% by weigh) and the polypropylene resin (C-1) used was a propylene homopolymer (MFR=120 g/10 min). The maleic anhydride modified polypropylene resin used was prepared according to a method described in Example 1 of Japanese Patent Laid-Open Publication No. 2004-197068.

The obtained fiber reinforced pellets were subjected to injection molding and the tensile strength, flexural modulus, flexural strength and weight average fiber length of the obtained samples were measured, and the results are shown in Table 1.

### Comparative Example 1

Evaluation was performed by the same method as in Example 1 except that polyvinyl alcohol fibers D-1 (fiber diameter, 14 μm; adhesion amount of the sizing agent, 0 parts by weight) produced by Kuraray Co., Ltd., which was a product before being applied with the sizing agent, was used in substitution for the polyvinyl alcohol fiber (A-1) produced by Kuraray Co., Ltd. (fiber diameter, 14 μm; adhesion amount of the sizing agent, 5 parts by weight) used in Example 1.

### Example 2

Evaluation was performed by the same method as in Example 1 except that a glycidyl methacrylate modified polypropylene resin (B-2) was used in substitution for the maleic anhydride modified polypropylene resin (B-1) and the composition was changed to that described in Table 1.

The modified polyolefin resin (B-2) used was a glycidyl methacrylate modified polypropylene resin (MFR=20 g/10 min; glycidyl methacrylate graft amount=0.5% by weight). The glycidyl methacrylate modified propylene resin used was prepared following the method described in Example 4 of Japanese Patent Laid-Open Publication No. 2004-291171.

### Comparative Example 2

Evaluation was performed by the same method as in Example 2 except that polyvinyl alcohol fibers D-1 (fiber diameter, 14 μm; adhesion amount of the sizing agent, 0 parts by weight) produced by Kuraray Co., Ltd., which was a product before being applied with the sizing agent, was used in substitution for the polyvinyl alcohol fiber (A-1) produced by Kuraray Co., Ltd. (fiber diameter, 14 μm; adhesion amount of the sizing agent, 5 parts by weight) used in Example 1.

### Comparative Example 3

Fiber reinforced pellets having a fiber content of 23% by weight and a pellet length of 9 mm were produced according to the method described in Japanese Patent Laid-Open Publication No. H03-121146 with the composition described in Table 1. The length of the polyvinyl alcohol fiber of the obtained fiber reinforced pellets is 9 mm.

For component (A), the component (A-1) used in Example 1 was used.

The modified polyolefin resin (B-1) used was a maleic anhydride modified polypropylene resin (MFR=60 g/10 min; maleic anhydride graft amount=0.6% by weight). Here, the maleic anhydride modified polypropylene resin used was prepared according to the method described in Example 1 of Japanese Patent Laid-Open Publication No. 2004-197068.

The obtained fiber reinforced pellets were subjected to injection molding and the tensile strength, flexural modulus, flexural strength and weight average fiber length of the obtained samples were measured, and the results are shown in Table 1.

### Comparative Example 4

Evaluation was performed by the same method as in Comparative Example 3 except that polyvinyl alcohol fibers D-1 (fiber diameter, 14 μm; adhesion amount of the sizing agent, 0 parts by weight) produced by Kuraray Co., Ltd., which was a product before being applied with the sizing agent, was used in substitution for the polyvinyl alcohol fiber (A-1) produced by Kuraray Co., Ltd. (fiber diameter 14 μm; adhesion amount of the sizing agent, 5 parts by weight) used in Example 1.

TABLE 1

| Mixture (parts by | | Comparative | | Comparative | Comparative | Comparative |
|---|---|---|---|---|---|---|
| weight) | Example 1 | Example 1 | Example 2 | Example 2 | Example 3 | Example 4 |
| (A) Polyvinyl | | | | | | |
| alcohol fiber | | | | | | |
| Kind of Fiber | A-1 | — | A-1 | — | A-1 | — |
| Amount | 26 | — | 31 | — | 23 | — |
| (B) Modified | | | | | | |
| polyolefin resin | | | | | | |
| Kind of Resin | B-1 | B-1 | B-2 | B-2 | B-1 | B-1 |
| Amount | 4 | 4 | 3 | 3 | 77 | 77 |
| (C) Polypropylene | | | | | | |
| resin | | | | | | |
| Kind of Resin | C-1 | C-1 | C-1 | C-1 | — | — |
| Amount | 70 | 70 | 66 | 66 | — | — |
| (D) Others | | | | | | |
| Kind of Fiber | — | D-1 | — | D-1 | — | D-1 |
| Amount | — | 26 | — | 31 | — | 23 |
| Evaluation results | | | | | | |
| Tensile strength | 92 | 86 | 102 | 78 | 82 | 65 |
| (MPa) | | | | | | |
| Flexural modulus | 4020 | 4010 | 4900 | 4600 | 3100 | 2860 |
| (MPa) | | | | | | |
| Flexural strength | 91 | 89 | 95 | 84 | 64 | 57 |
| (MPa) | | | | | | |
| Specific gravity (—) | 0.99 | 0.99 | 1.00 | 1.00 | 0.97 | 0.98 |
| Weight average | 8 | 8 | 8 | 8 | 8 | 8 |
| fiber length (mm) | | | | | | |

It can be understood that Examples 1 and 2 are excellent in tensile strength and flexural strength.

In contrast, it can be understood that Comparative Examples 1 to 4 are insufficient in tensile strength and flexural strength.

1. A polyvinyl alcohol fiber-containing polyolefin resin composition, comprising:
1 to 70% by weight of polyvinyl alcohol fibers (A) containing 100 parts by weight of polyvinyl alcohol filaments (A-I) and 0.1 to 10 parts by weight of a sizing agent (A-II); and
30 to 99% by weight of a polyolefin resin composition (I),
wherein the polyolefin resin composition (I) contains 0.5 to 40% by weight of a modified polyolefin resin (B) produced by modifying a polyolefin resin with an unsaturated carboxylic acid and/or an unsaturated carboxylic acid derivative and 60 to 99.5% by weight of a polyolefin resin (C) with respect to the total weight of the polyolefin resin composition (I).

2. The polyvinyl alcohol fiber-containing polyolefin resin composition according to claim 1, wherein the sizing agent (A-II) is a polypropylene resin and/or a modified polypropylene resin.

3. The polyvinyl alcohol fiber-containing polyolefin resin composition according to claim 1, wherein the length of the polyvinyl alcohol fiber (A) is 2 to 50 mm, and the external form is a form of a pellet.

4. A molded article obtained from a polyvinyl alcohol fiber-containing polyolefin resin composition according to claim 1.

5. The polyvinyl alcohol fiber-containing polyolefin resin composition according to claim 2, wherein the length of the polyvinyl alcohol fiber (A) is 2 to 50 mm, and the external form is a form of a pellet.

6. A molded article obtained from a polyvinyl alcohol fiber-containing polyolefin resin composition according to claim 2.

7. A molded article obtained from a polyvinyl alcohol fiber-containing polyolefin resin composition according to claim 3.
